(19) United States
(12) Patent Application Publication
(10) Pub. No.: US 2025/0343470 A1
(43) Pub. Date: Nov. 6, 2025

(54) ELECTRIC MACHINE HEAT EXCHANGER

(71) Applicants: SAFRAN AIRCRAFT ENGINES, Paris (FR); SAFRAN ELECTRICAL AND POWER UK LTD., Pitstone Buckinghamshire (GB)

(72) Inventors: Alfonso VILLANUEVA, Pitstone Buckinghamshire (GB); Paco MAURER, Paris (FR); Wei WANG, Pitstone Buckinghamshire (GB)

(21) Appl. No.: 18/862,213

(22) PCT Filed: May 6, 2022
(86) PCT No.: PCT/IB2022/000249

§ 371 Date: Nov. 1, 2024

(51) Int. Cl. H02K 9/197; B64D 27/30; B64D 33/10

(52) U.S. Cl. CPC H02K 9/197; B64D 27/30; B64D 33/10

(57) ABSTRACT

A heat exchanger for an electric machine. The electric machine includes a stator having a stator core and stator slots extending along a longitudinal axis of the stator, and a rotor assembly having a rotor configured to rotate about the longitudinal axis. The electric machine includes a coolant system having a stator cooling path providing a first coolant fluid in direct contact with the stator to flow around the stator core and through the stator slots. The coolant system also includes a coolant circuit providing a second coolant fluid to at least one rotatable component of the electric machine, such as at least one bearing. The coolant circuit and the stator cooling path are fluidically isolated from one another and arranged such that heat is exchanged between the first coolant fluid and the second coolant fluid at the stator.

### TECHNICAL FIELD

The invention relates to a heat exchanger for an electric machine. In particular, this invention relates to a heat exchanger comprised in an electric machine for an aircraft engine.

### BACKGROUND OF THE INVENTION

Electric machines, such as electric generators, have both an operating temperature range (within which they can operate) and an optimum temperature range (within which they operate most efficiently). In use, electric generators create heat due to inefficiencies in generation. Electric generators are typically cooled by a circulating fluid to ensure a) that they are kept within the operating temperature range, and b) that they are preferably kept in their optimum temperature range.

Aircraft propulsion systems typically comprise an engine which may be connected to an electric generator. In such systems, the electric generator may be driven by a turbine of the engine to generate the electricity needed to power the aircraft's electrical consumption.

Generally, aircraft engine electric generators are cooled using an oil filled system by circulating oil being driven by a mechanical pump. To reduce the number of system components, some modern aircraft engines use a single oil system to cool multiple parts of the aircraft engine, such as both the gearbox and the generator being cooled from a single cooling circuit using a shared fluid flow. However, failure of this single oil system will lead to multiple parts of the aircraft engine overheating, which can lead to a failure of the engine as a whole. Further, failure in one engine area, such as the generator, might cause knock-on effects in another system by contaminants being distributed by the shared fluid flow.

To improve redundancy, in some aircraft engines the electric generator may have its own self-contained coolant system, complete with its own coolant path, mechanical pump, gearbox and connection to a drive shaft. However, in restricted space environments having multiple redundant coolant systems is often challenging. The reason this is challenging is that, in aircraft applications, the electric generators are typically under the highest load during idling of the aircraft before take-off. At this time, all of the aircraft's systems will be operating, and the aircraft's entertainment and galley systems may be starting up.

During idling, the aircraft's engines will be turning at their lowest speeds (as no thrust is required), hence the drive to the coolant pumps will be at its lowest speed. Additionally, with generators running at lowest speed, currents will be highest and so heat generated due to resistance in them will also be high. To cope with these requirements, prior art coolant systems have been designed to provide sufficient fluid flow at idling speeds to cope with maximum generator output. Thus high cooling capacity coolant systems are required to keep the electric generators from overheating at idle speeds with high demand.

UK UK Patent No. 2570656 describes a coolant system for an electric generator having a turbine driven by fluid in a propulsion system fluid circuit. The turbine drives a pump which drives a coolant fluid around a separate cooling circuit.

There exists a need for improvements in generator cooling systems.

### SUMMARY OF THE INVENTION

According to an aspect of the present invention, there is provided an electric machine comprising any or all of the following features:
a stator comprising a stator core and a plurality of stator slots extending along a longitudinal axis of the stator;
a rotor assembly comprising a rotor configured to rotate about the longitudinal axis; and
a coolant system comprising:
   a stator cooling path configured to provide a first coolant fluid to flow around the stator core and through the stator slots; and
   a coolant circuit configured to provide a second coolant fluid to at least one rotatable component of the electric machine;
   wherein the coolant circuit and the stator cooling path are fluidically isolated from one another and are arranged such that heat is exchanged between the first coolant fluid and the second coolant fluid at the stator.

The at least one rotatable component of the electric machine may include cooled components of the rotor, such as the rotor bearings, the rotor itself, and components associated with the rotor such as splines and gear teeth. The term ‘rotatable component’ means a component that is configured to rotate during operation of the machine, and is used herein to distinguish the coolant circuit from the stator cooling path which is instead configured to provide coolant to stationary components, namely the stator core and stator slots, or any other component fixed to the housing and/or stator which is not configured to rotate in operation.

In order to integrate an electric machine into an aircraft engine in a standalone and modular fashion, the stator, rotor and corresponding bearings are preferably enveloped into the same package. The electric machine may be embedded in a tail cone at the rear of the low pressure turbine of an aircraft engine. A turbine rear frame (TRF) can be provided around the tail cone for structural and aerodynamic purposes. Furthermore, the stator, rotor and lubricating oil are preferably cooled, which is normally achieved by a cooling circuit linked to a heat exchanger located within the core compartment of the engine. The heat exchanger typically employs air or fuel as coolant and provides cooled fluid to the electric machine through a supply line and a return line running through a strut of the TRF.

The inventors have recognised that it is preferable for the oil for cooling the stator to be independent from the oil for lubricating and cooling components associated with the rotor, such as the bearings. Therefore, by providing a coolant system in which the coolant circuit for cooling at least one rotatable component of the rotor assembly is fluidically isolated from a stator cooling path for cooling the stator core and the stator slots, the system can accommodate the different requirements for each of the cooling circuits. For example, this system allows tailoring of the coolant type, coolant pressure and flow rate of the coolant used in the circuit. Furthermore, by providing the cooling circuits in a fluidically isolated manner, any metal debris in one cooling circuit will not enter another cooling circuit. It will be understood that the coolant may be any suitable fluid, such as a liquid or gas, and is not limited oil.

The present invention provides that heat is exchanged between the first coolant fluid and the second coolant fluid at the stator. A heat exchanger is therefore provided at the stator. Heat is therefore exchanged between the first and second coolant fluids at the same region as where heat is exchanged between the first coolant fluid and the stator. The TRF has a finite number of radial struts that can provide air, oil and electrical connections to the core of the low pressure turbine. Therefore, by integrating a heat exchanger at the stator of the electric machine, the system avoids the need of requiring additional supply and return lines for a separate cooling circuit which would need to be routed through the TRF. This reduces the drag in the flow path in the TRF because adding additional lines would require an increase in the thickness of one or more struts of the TRF, or would require adding a new strut to the TRF. By avoiding the need for additional supply and return lines for coolant, the modularity of the electric machine is thereby increased and its connection with the engine cooling system is simplified.

The invention also provides that the stator cooling path provides the first coolant fluid to flow around the stator core and through the stator slots. This is in contrast to prior coolant systems, which may employ a separate external jacket in order to cool the stator core and wherein the stator teeth defining the stator slots may be cooled merely by conduction through the stator core. By providing the first coolant fluid around the stator core and also through the stator slots, the first coolant fluid can contact a greater surface area of the stator, to thereby increase the efficiency of the cooling, while exchanging heat with the second coolant fluid in the same region, i.e. at the stator.

The stator cooling path may be configured to provide the first coolant fluid in direct contact with the stator. This has the advantage of increasing the efficiency of stator cooling by the first coolant fluid.

The stator may be comprised in a housing. The stator cooling path may be configured to provide the first coolant fluid between the stator and the housing. Therefore, the stator cooling path may comprise a portion defined in a region between the stator and the housing. The stator may be concentrically received within the housing, and the stator cooling path may comprise a portion disposed in an annular region between the stator and the housing. The stator cooling path may comprise a channel. The channel may be configured to provide the first coolant fluid between the stator and the housing. The channel may be at least partly defined by at least one recess in the housing. The channel may be at least partly defined by the stator. The channel may be at least partly defined by an outer radial surface of the stator core. This has the advantage of providing the first coolant fluid in direct contact with the stator while providing the cooling channel via the housing of the stator in order to reduce the number of components required.

The channel may be helical with respect to the longitudinal axis. That is to say, the stator cooling path may have a portion in the shape of a spiral around the stator. This has the advantage of delivering first coolant fluid around the circumference of the stator and axially along the outer radial surface of the stator.

The channel of the stator cooling path may be a first channel and the coolant circuit may comprise a second channel. The second channel may be at least partly disposed within or adjacent to the first channel. The second channel may be configured to provide the second coolant between the housing and the stator. The second channel may be disposed in the annular region defined between the stator and the housing. The second channel may have a corresponding shape to the first channel. The second channel may be helical. The first and second channels may be in the form of a helix having the same pitch. The second channel may comprise a helical duct received by the first channel.

The stator cooling path may comprise a plurality of longitudinal recesses defined in the housing. The coolant circuit may be configured to be received by the plurality of longitudinal recesses defined in the housing.

The present invention also provides an aircraft engine assembly comprising the electric machine described hereinabove. The electric machine may be driven by an output of an engine of the aircraft engine assembly. The stator cooling path may be configured to direct the first coolant fluid from the electric machine to the engine compartment in order to cool the first coolant fluid. The present invention also provides an aircraft comprising the aircraft engine assembly described hereinabove.

### BRIEF DESCRIPTION OF THE DRAWINGS

Further features and advantages of the present invention will become apparent from the following description of embodiments thereof, presented by way of example only, and by reference to the drawings, in which:

FIG. 1 is a schematic diagram illustrating a coolant system of an electric machine according to an embodiment;

FIG. 2 is a sectional view of an electric machine according to an embodiment;

FIG. 3 is a perspective view of a stator of an electric machine according to an embodiment;

FIG. 4A is a cut-away view illustrating the stator according to an embodiment;

FIG. 4B is a perspective view of part of a coolant circuit according to an embodiment;

FIG. 5 is an exploded diagram of a stator housing and part of a coolant circuit according to an embodiment;

FIG. 6 is a schematic diagram of an aircraft according to an embodiment.

### DETAILED DESCRIPTION

An electric machine is disclosed in the context of an aircraft engine assembly. The electric machine disclosed herein includes a stator having a longitudinal axis. The stator may be formed of a plurality of stator laminations stacked together along the longitudinal axis. The stator has a stator core and a plurality of stator teeth extending radially from the stator core to define a plurality of slots. Such stator slots are configured to receive conductors for carrying electric current. The conductors may be in the form of stator windings or solid bar conductors. The electric machine also comprises a rotor configured to rotate about the longitudinal axis of the stator. The rotor can include a plurality of permanent magnets, or non-permanent magnetisable elements such as windings, which produce a changing magnetic field as the rotor rotates about the axis, to thereby generate an electric current in the stator conductors. As such, the electric machine can operate as an electric generator. It will be understood that the electric machine could also operate as an electric motor. The rotor may be formed in a rotor assembly which is journaled for rotation relative to the stator by one or more bearings.

The stator is cooled by a first coolant fluid flowing around the stator core and through the stator slots. This stator cooling path may be supplied with coolant from a coolant circuit external to the electric machine, for example from the main engine compartment. After the first coolant has flowed around the stator, the first coolant fluid is returned to the external heat exchanger to be cooled and recirculated. The rotor, bearings and other associated elements such as splines or gear teeth are cooled and lubricated by a second coolant fluid. The second coolant fluid is circulated around the electric machine by a coolant circuit comprised within the electric machine. The first and second coolant fluids may be oil. Instead of cooling the second coolant fluid via an external heat exchanger, the electric machine disclosed herein is arranged such that heat is exchanged between the first coolant fluid and the second coolant fluid in the electric machine. This allows the second coolant fluid to be cooled by the first coolant fluid. To achieve this, the second coolant fluid circulating in the coolant circuit is brought into close contact with the first coolant fluid in the stator cooling path. For example, the coolant circuit may have a duct that runs within the stator cooling path such that the first coolant fluid is configured to at least partially surround the second coolant fluid. Once the second coolant fluid has been cooled by the first coolant fluid, the coolant circuit is configured to circulate the second coolant fluid towards rotatable components of the rotor and/or the bearings, before returning to a sump.

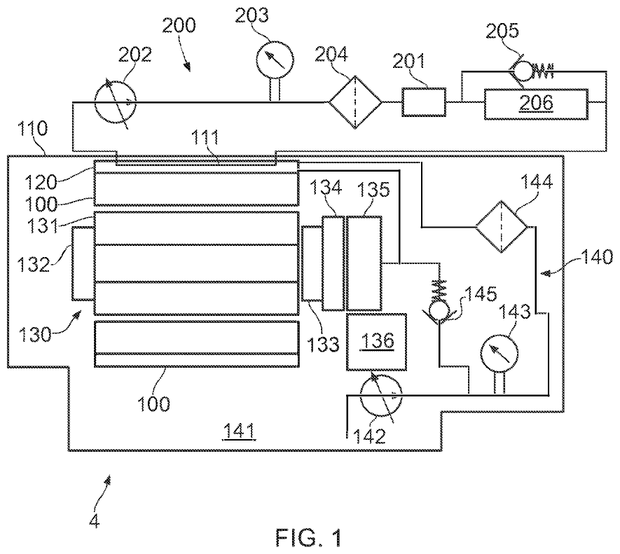

FIG. 1 is a circuit diagram including an electric machine 4 according to embodiments of the invention. The electric machine 4 comprises a stator 100 and a rotor assembly 130. The stator 100 and the rotor assembly 130 may be contained in a housing 110. In the arrangement shown, the rotor assembly 130 includes a rotor 131 configured to rotate around a longitudinal axis of the stator 100. The rotor assembly 130 may be journaled to rotate relative to the housing 110 by one or more bearings 132, 133. In the illustrated arrangement, the rotor assembly 130 is supported by a first bearing 132 at a first axial end of the rotor assembly 130, and is supported by a second bearing 133 at an opposite second axial end of the rotor assembly 130.

The electric machine 4 comprises a coolant system. The coolant system comprises a stator cooling path 111 and a coolant circuit 140. The stator 100 is cooled by a first coolant fluid (not shown) provided by the stator cooling path 111. The first coolant fluid may be circulated by an external coolant circuit 200 which may be external to the electric machine 4. The external coolant circuit 200 may comprise a tank 201 to store the first coolant fluid, together with a filter 204 and a pressure sensor 203. The first coolant fluid may be pumped around the external coolant circuit 200 by a pump 202. Downstream of the stator cooling path 111, the external coolant circuit 200 may comprise an external heat exchanger 206 and a bypass valve 205.

The external coolant circuit 200 may be part of the core compartment of the engine. The first coolant fluid can be transported towards the stator cooling path 111 of the electric machine 4 by a supply line (not shown) running through a strut of the turbine rear frame (not shown) and can be returned to the heat exchanger 206 via a return line through a strut of the turbine rear frame.

The coolant circuit 140 is configured to provide a second coolant fluid to at least one bearing 132, 133, and/or at least one rotatable component of the rotor assembly. Such rotatable components may include any component of the rotor assembly such as a disconnect mechanism 134, an input shaft bearing 135, and other cooled components such as gear meshes and bearings 136, which may need to be lubricated and/or cooled by the coolant circuit 140. The coolant circuit 140 of the electric machine 4 may comprise a sump 141 for storing the second coolant fluid, a pump 142 for pumping the second coolant fluid around the coolant circuit 140, a pressure sensor 143 for measuring the pressure of the second coolant fluid, a filter 144 for filtering the second coolant fluid and a pressure relief valve 145.

The coolant circuit 140 and the stator cooling path 111 are fluidically isolated from one another. That is to say, the coolant system is arranged such that the first and second coolant fluids do not come into contact with one another. In order to cool the second coolant fluid flowing around the coolant circuit 140, a heat exchanger 120 is provided within the electric machine 4. The coolant circuit 140 may be configured such that the second coolant fluid is cooled by the heat exchanger 120 before flowing towards cooled components such as the bearings 132, 133 to thereby cool and lubricate them, before returning to the sump 141 to be recirculated. As such, heat is exchanged between the first coolant fluid and the second coolant fluid. The heat exchanger 120 can be provided at the stator 100. That is to say, the heat exchanger 120 can be provided adjacent to and/or around the stator 100. In this way, heat is exchanged between the first coolant fluid and the second coolant fluid at the stator 100. Therefore, the first coolant fluid in the stator cooling path 111 can be configured to cool the second coolant fluid in the coolant circuit 140 at the stator 100.

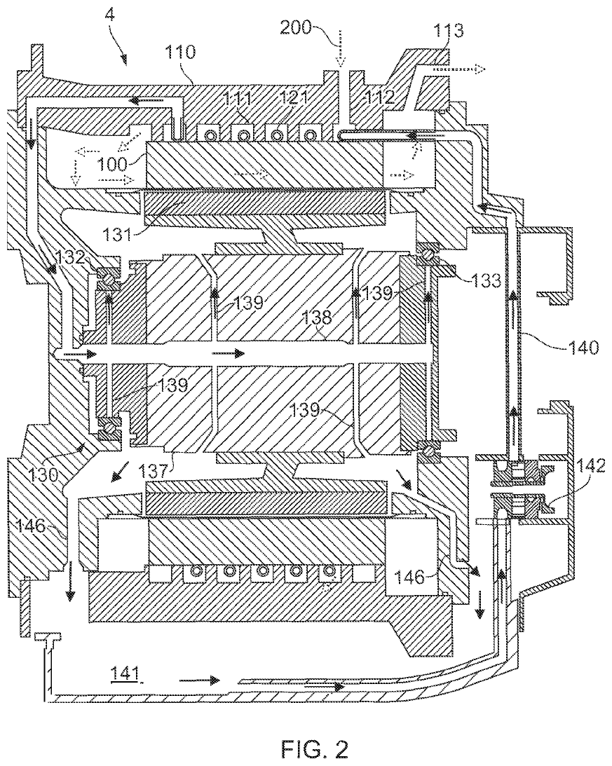

FIG. 2 is a sectional view of the electric machine 4 according to embodiments of the invention. In the arrangement shown, the rotor assembly 130 comprises shaft 137, which may be a low pressure (LP) shaft, connected to the rotor 131. The LP shaft 137 is rotatably received in the electric machine 4 by the first and second bearings 132, 133. The rotor 131 is mechanically connected to the LP shaft 137 and is configured to rotate therewith.

The shaft 137 may be configured to distribute coolant in the coolant circuit to cooled components of the electric machine 4. In the arrangement shown, the shaft 137 comprises an axial bore 138. The axial bore 138 is configured to transfer coolant from one axial end of the shaft to the other axial end of the shaft 137. The shaft 137 may also include one or more passages 139. The passages 139 may be fluidically connected to the bore 138 and may be configured to distribute coolant radially from the axial bore 138. In this way, the shaft 137 is configured to transfer the second coolant fluid therealong via the axial bore 138 while providing coolant fluid to the cooled components of the electric machine 4 via the passages 139.

The solid arrows in FIG. 2 represent the direction of flow of the second coolant fluid circulating in the coolant circuit 140. Starting from the sump 141, the coolant circuit 140 is configured to transfer the second coolant fluid towards the heat exchanger 120 at the stator 100 by the action of the pump 142. Downstream of the heat exchanger 120, the second coolant fluid may be transferred to other cooled components of the electric machine 4 via one or more conduits in the electric machine 4. In the arrangement shown, the coolant system 140 is configured to transfer the second coolant fluid through the housing 110 to the rotor assembly 130. At this point, the second coolant fluid can be provided to the bore 138 of the LP shaft 137 in order to supply the bearings 132, 133 and other cooled components with the second coolant fluid via the passages 139. The coolant circuit 140 of the electric machine 4 may also include one or more return passages 146 configured to direct the second coolant fluid back to the sump 141.

The dashed arrows in FIG. 2 represent the flow of the first coolant fluid in the external coolant circuit 200. In the arrangement shown, the housing 110 comprises a supply channel 112 in fluid communication with the external coolant circuit 200. The supply channel 112 may be configured as a passage for transferring the first coolant fluid from a first surface of the housing 110 to a second surface of the housing 110. In the arrangement shown, the supply channel 112 is formed of a radially extending bore in fluid communication with the stator cooling path 111. In this way, the housing 110 is configured to transfer the first coolant fluid from the external coolant circuit 200 to the stator cooling path 111. Downstream of the stator cooling path 111 may be an outlet 113 configured to transfer the first coolant fluid out of the electric machine 4.

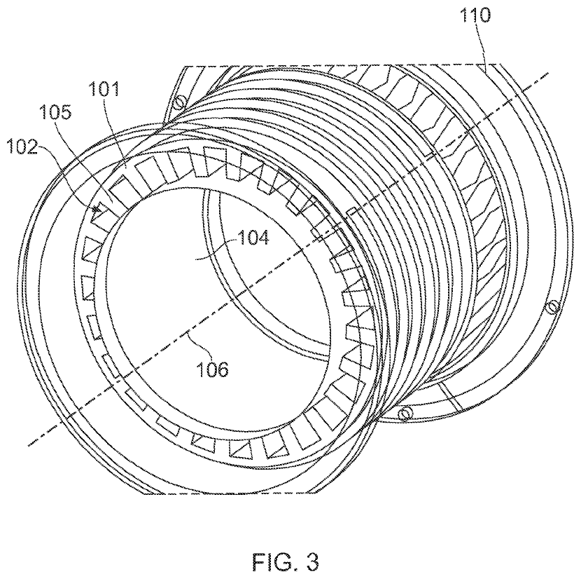

FIG. 3 illustrates a portion of the electric machine 4, in particular the stator 100 in the housing 110. The stator 100 comprises a stator core 101 and a plurality of stator slots 102, which may be defined by a plurality of stator teeth 105 extending radially from the stator core 101. The housing 110 may form a jacket around the stator 100 in order to provide a space for coolant fluid to flow around the stator core 101. Furthermore, the electric machine 4 may comprise a stator sealing sleeve 104. In the arrangement shown, the stator sealing sleeve 104 is disposed around the longitudinal axis 106 of the stator 100 and may be formed as a cylindrical sleeve provided radially inwards of the stator slots 102. In this way, the stator core 101, stator teeth 102 and the stator sleeve 104 can provide a series of longitudinally extending channels through which coolant may flow in order to cool the stator slots 102 and the conductors therein. The stator sealing sleeve 104 may comprise glass fibres. The stator cooling path 111 is configured to provide the first coolant fluid to flow around the stator 100, in particular to flood the stator 100. As such, the stator cooling path 111 may include the stator slots 102 and the space provided around the stator core 101. In other words, the stator cooling path 111 represents a route around the stator 100 that may be taken by the first coolant fluid in order to cool the stator core 101 and the stator slots 102.

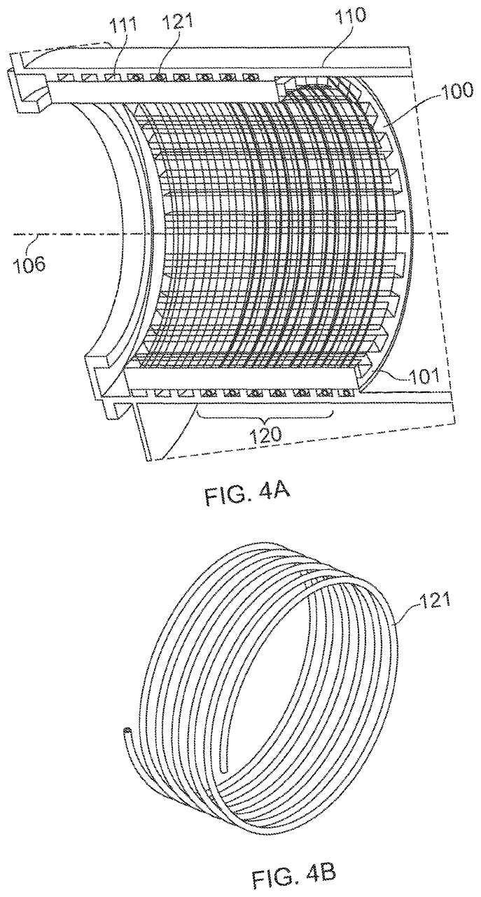

FIG. 4A shows further detail of the housing 110 and the stator 100 according to embodiments of the present invention. At least part of the stator cooling path 111 may be configured to provide the first coolant between the stator 100 and the housing 110. In the arrangement shown, the stator core 101 has an outer radial surface which is cylindrical. The stator cooling path 111 may be at least partly disposed around the outer radial surface.

The stator cooling path 111 may comprise at least one channel disposed around the longitudinal axis 106 of the stator 100. The channel may be configured to provide the first coolant fluid between the stator 100 and the housing 110. In the arrangement shown, the channel is at least partly defined by one or more recesses in the housing 110 and is at least partly defined by the stator 100, in particular by the stator core 101. The channel may comprise a portion defined by one or more surfaces of the housing 110 and one or more surfaces of the stator 100. The channel may have a rectangular cross-section. In the arrangement shown, one side of the rectangular cross-section is defined by the stator 100, more particularly the stator core 101. In this way, the stator cooling path 111 can be arranged to provide the first coolant fluid in direct contact with the stator 100. The remaining three sides of the rectangular cross-section may be defined by a recess in the housing 110. In the arrangement shown, the channel is in the form of a helix disposed around the longitudinal axis 106. In this way, the stator cooling path 111 may be configured to provide the first coolant around and along one or more surfaces of the stator 100.

With reference to FIGS. 4A and 4B, the coolant circuit 140 may comprise a duct 121, which may be in the form of a helical tube or pipe. The duct 121 represents a portion of the coolant circuit 140 configured to circulate the second coolant fluid through the heat exchanger 120. In the arrangement shown, the duct 121 is received within the stator cooling path 111. In particular, the duct 121 is received by the helical channel which partly defines the stator cooling path 111 around the stator 100. As such, the stator cooling path 111 and the duct 121 can together form the heat exchanger 120.

The arrangement of the heat exchanger 120 is not limited to a helical duct 121 disposed in a helical channel formed in the stator cooling path 111. In an alternative embodiment, the heat exchanger may comprise first and second channels running in parallel at least partially around or along the stator core 101. The first and/or second channels may be helical or may at least partially extend longitudinally or axially along the stator. The first channel may be in fluid communication with the stator cooling path 111 in order to provide the first coolant fluid to the stator, while the second channel may be in fluid communication with the coolant circuit 140 in order to circulate the second coolant fluid through the heat exchanger 120.

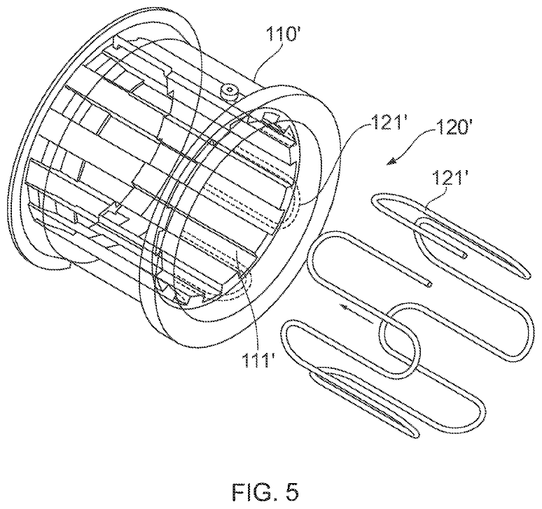

FIG. 5 shows a further embodiment of a heat exchanger 120′ comprising a stator cooling path 111′ and a duct 121′. In this arrangement, the stator cooling path 111′ comprises a plurality of longitudinally extending channels, which may be provided as recesses in the housing 110′. Such channels may be fluidly connected to one another at their respective ends in order to form a path for coolant fluid to flow around the stator core 101. The channels may be configured to receive the duct 121′ which may have a corresponding shape to the channels. In the arrangement shown, the duct 121′ is boustrophedonic. That is to say, the duct 121′ may have a shape configured such that the second coolant fluid can flow along an axis in a first longitudinal direction before changing direction and flowing along the axis in the opposite second longitudinal direction, before changing direction again and flowing in the first longitudinal direction, and so on. As shown in FIG. 5, this shape may be formed into a notional cylinder configured to be received within the housing 110 in the axial direction indicated by the arrow in the figure, in particular within the channels of the stator cooling path 111′, as shown by the dashed lines representing the duct 121′ within the housing 110′.

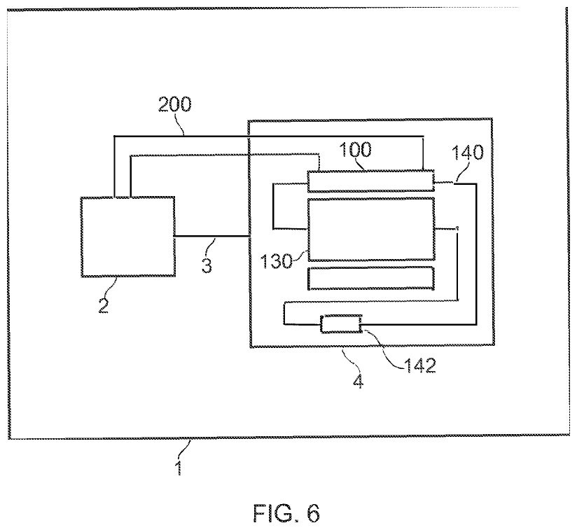

FIG. 6 is a schematic diagram illustrating an aircraft 1. The aircraft comprises an aircraft engine 2 connected to an external coolant circuit 200. The aircraft further comprises the electric machine 4, including the stator 100, rotor assembly 130 and coolant circuit 140 that may be driven by a pump 142. The electric machine 4 may be driven by the engine 2 via an input shaft 3. Heat can be exchanged between the second coolant fluid in the coolant circuit 140 and the first coolant fluid in the external coolant circuit 200 at the stator 100.

Various modifications, whether by way of addition, deletion and/or substitution, may be made to all of the above-described embodiments to provide further embodiments, any and/or all of which are intended to be encompassed by the appended claims.

1. An electric machine comprising:
a stator comprising a stator core and a plurality of stator slots extending along a longitudinal axis of the stator;
a rotor assembly comprising a rotor configured to rotate about the longitudinal axis; and
a coolant system comprising:
a stator cooling path configured to provide a first coolant fluid in direct contact with the stator and to flow around the stator core and through the stator slots; and
a coolant circuit configured to provide a second coolant fluid to at least one rotatable component of the electric machine;
wherein the coolant circuit and the stator cooling path are fluidically isolated from one another and are arranged such that heat is exchanged between the first coolant fluid and the second coolant fluid at the stator.

2. The electric machine according to claim 1, wherein the stator is comprised in a housing and the stator cooling path is configured to provide the first coolant fluid between the stator and the housing.

3. The electric machine according to claim 2, wherein the stator cooling path comprises a channel configured to provide the first coolant fluid between the stator and the housing.

4. The electric machine according to claim 3, wherein the channel is at least partly defined by at least one recess in the housing.

5. The electric machine according to claim 3, wherein the channel is at least partly defined by the stator.

6. The electric machine according to claim 3, wherein the channel is helical with respect to the longitudinal axis.

7. The electric machine according to claim 3, wherein the channel of the stator cooling path is a first channel and the coolant circuit comprises a second channel, the second channel being at least partly disposed within the first channel.

8. The electric machine according to claim 7, wherein the second channel comprises a helical duct received by the first channel.

9. The electric machine according to claim 1, wherein the coolant circuit is configured to provide the second coolant fluid between the housing and the stator.

10. The electric machine according to claim 1, wherein the stator cooling path comprises a plurality of longitudinal recesses defined in the housing.

11. An aircraft engine assembly comprising the electric machine according to claim 1.

12. An aircraft comprising the aircraft engine assembly according to claim 11.

13. The electric machine according to claim 3, wherein the channel of the stator cooling path is a first channel and the coolant circuit comprises a second channel, the second channel being at least partly disposed adjacent the first channel.

14. The electric machine according to claim 13, wherein the second channel comprises a helical duct received by the first channel.
